(19) United States
(12) Patent Application Publication
(10) Pub. No.: US 2024/0212119 A1
(43) Pub. Date: Jun. 27, 2024

(54) METHOD FOR ASSESSING THE QUALITY OF PROFILES LWD IMAGE

(71) Applicant: PETRÓLEO BRASILEIRO S.A. - PETROBAS, Rio de Janeiro (BR)

(72) Inventors: Ciro Dos Santos Guimaraes, Rio de Janeiro (BR); Ralph Engel Piazza, Rio de Janeiro (BR)

(73) Assignee: PETRÓLEO BRASILEIRO S.A. - PETROBAS, Rio de Janeiro (BR)

(21) Appl. No.: 18/392,112

(22) Filed: Dec. 21, 2023

(30) Foreign Application Priority Data
Dec. 22, 2022 (BR) 1020220264180

(51) Int. Cl. G06T 7/00; E21B 47/002

(52) U.S. Cl. CPC G06T 7/0002; E21B 47/002; E21B 2200/20; E21B 2200/22; G06T 2207/20084; G06T 2207/30168; G06T 2207/30181

(57) ABSTRACT

The present invention relates to a method for assessing the quality of LWD (Logging While Drilling) image logs, comprising the processing of a plurality of LWD image logs; subdividing the LWD image logs into smaller pseudo-images of the same size; performing the normalization of each pseudo-image of the LWD image logs; and classifying the LWD image log according to its quality, which comprises classifying a plurality of sections of the LWD image log into three quality categories, including: good, medium or poor, using a trained neural network model for quality assessment of the LWD image log.

### FIELD OF THE INVENTION

The present invention falls under the technical field of modeling, simulation and assessment of reservoirs. More specifically, the present invention relates to a method for assessing the quality of LWD (Logging While Drilling) image logs.

### BACKGROUNDS OF THE INVENTION

The acquisition of petrophysical data on oil wells is a key activity to support the adequate development of a deposit.

By acquiring data on the rocks drilled during well drilling activities, as well as data on the fluids contained in these rocks, it becomes possible to develop a development strategy for the field in question, aiming at optimizing the recovery of hydrocarbons over time. Additionally, the information contained in petrophysical data has great value in decision-making regarding well completion.

In this sense, the acquisition of petrophysical data can be carried out in two ways: the first, called LWD (Logging While Drilling) logging, is carried out during the drilling of the well, by using tools positioned in the drilling string, close to the drill; the second, called Wireline logging, uses wireline tools that are lowered into the well after drilling is completed and before the production casing is installed.

Particularly, after completing the acquisition of petrophysical data, these are sent to subject matter experts, who process and interpret the data, subsequently incorporating the information into geological models of the fields.

The technological evolution achieved by logging tools has allowed that, in general, petrophysical data can be acquired both through LWD tools and through wireline tools. Therefore, as a rule, it is possible for one type of operation to completely replace the other.

In particular, in scenarios where the data of interest can be obtained with quality during the well drilling itself, using LWD tools, there are significant financial and time gains for a company. This is due to the fact that LWD acquisitions have three important characteristics that distinguish them from wireline acquisitions: information about the drilled rocks is known in real time, which allows operational decisions to be made about the trajectory and length of the well in a more quickly way and with a greater degree of reliability; the drill string allows LWD logging tools to reach high-incline or even horizontal sections of the well with relative ease, which is not true for wireline-running-in tools; and string acquisition does not consume rig time in addition to the drilling time itself, as the activities are carried out concomitantly.

In contrast, data acquisition via wireline logging requires the assembly and disassembly of the logging circle in the rotary table area, time for running in and passing the wireline logging tools in front of the reservoir, as well as additional time for conditioning the well after logging is completed. In this way, it is possible to note that, in addition to the additional time postponing the completion of the well construction and, as a consequence, the start of the next intervention planned for the rig, the additional time also directly impacts the operation budget, as it attributes to the well the cost of renting the rig during this period, for example.

However, certain petrophysical data, despite being available both through acquisition via LWD logging tool and wireline logging, tend to have better quality when acquired via wireline logging, as the logging environment for this operation is much less noisy than that found during the drilling of the well, where LWD logging operates. Furthermore, during wireline logging, the well is better conditioned for data acquisition, carrying fewer suspended solids and a more homogeneous drilling fluid.

Considering the fact that the acquisition of petrophysical data by wireline logging occurs after the acquisition by LWD logging, in principle, it would be possible to choose to perform additional wireline logging to acquire data again containing a resistive image log, when its quality is not satisfactory when acquired using LWD logging. In this way, it would be possible to guarantee the acquisition of good quality data in the well under construction.

However, in practice, it is not feasible to manually assess the quality of said image log acquired with LWD logging in a timely manner to decide on the need to carry out an additional acquisition through wireline logging.

In particular, an image log has a large amount of data and requires a long time to be processed and analyzed by a specialist in the technique, time greater than that normally available between the two data acquisition operations.

An alternative solution, consisting of obtaining the image log via wireline logging in a conservative manner, without prior assessment of the quality of the image log obtained by LWD logging, could lead to a waste of the financial and physical resources of a company.

Based on these limitations, there is a need to automate the process of assessing the quality of the resistive image logs acquired via LWD logging, with the aim of making it viable in time to decide on the need to acquire the same resistive image log via wireline logging.

Furthermore, the need for a solution that is capable of analyzing criteria subject to the subjectivity of the human interpretation in relation to the quality of resistive image logs is evident.

### STATE OF THE ART

In the state of the art, there are some solutions involving the use of machine learning and artificial intelligence techniques applied to the resistive image log acquired by LWD logging, as presented in the following document.

Document US2022090481A1 describes a method and system for processing LWD image log data, generating image data in relation to the region of interest, using neural network, while well log data is being acquired in the well. Furthermore, such a describes the document transmission, based on the drilling parameter, of a command to a drilling system coupled to the well. However, this solution does not encompass the assessment of the quality of the resistive image logs acquired via LWD logging.

Therefore, there is a need for a method to assess the quality of LWD image logs, automatically, allowing decision-making regarding the need to use wireline logging, in a timely and efficient manner.

Furthermore, there is a clear need for a solution that is capable of analyzing criteria subject to the subjectivity of the human interpretation regarding the quality of resistive image logs.

### BRIEF DESCRIPTION OF THE INVENTION

The present invention relates to a method for assessing the quality of LWD (Logging While Drilling) image logs comprising performing the processing of a plurality of LWD image logs; subdividing the LWD image logs into smaller pseudo-images of the same size; performing the normalization of each pseudo-image of the LWD image logs; and classifying the LWD image log according to its quality, which comprises classifying a plurality of sections of the LWD image log into three quality categories, including: good, medium or poor, using a trained neural network model for quality assessment of the LWD image log.

Furthermore, according to a preferred embodiment of the present invention, the step of processing a plurality of LWD image logs comprises removing spurious points from the LWD image logs.

Additionally, the step of processing a plurality of LWD image logs additionally comprises defining a single classification window of 120 rows and 120 columns.

The method for assessing the quality of LWD image logs, preferably, additionally comprises performing data augmentation.

In accordance with a preferred embodiment, the good quality category comprises a section where it is possible to identify boundaries between rock layers, as well as textural elements internal to the layers; the medium quality category comprises a section where it is possible to identify boundaries between layers of rocks, but it is not possible to identify elements internal to them; and the poor quality category comprises a missing section of boundaries between layers or their internal characteristics.

In addition, according to a preferred embodiment, the neural network model for assessing the quality of the LWD image log comprises a convolutional neural network architecture followed by a direct network; most preferably, the convolutional neural network is a VGG16 network.

Based on the limitations of the state of the art, the present invention automates the method for assessing the quality of LWD image logs with the aim of making it viable in time to decide on the need to acquire the image log via a wireline logging tool.

### BRIEF DESCRIPTION OF THE FIGURES

In order to complement the present description and obtain a better understanding of the features of the present invention, and in accordance with a preferred embodiment thereof, a set of figures is presented, which in an exemplified, although not limiting, manner represents its preferred embodiment.

FIG. 1 illustrates the result of the LWD image log quality classification for a well.

FIG. 2 represents the second step of processing a plurality of LWD image logs.

FIG. 3 presents the data augmentation procedure.

FIG. 4 illustrates a training graph of the neural network model.

FIG. 5.1 shows the result of a blind test, comparing the response of the neural network model with the responses on the classifications given by expert petrophysicists.

FIG. 5.2 highlights the assessment metrics of the trained neural network model to perform the method of the present invention.

### DETAILED DESCRIPTION OF THE INVENTION

The present invention relates to a method for assessing the quality of LWD (Logging While Drilling) image logs, which comprises the steps as described below.

According to a preferred embodiment of the present invention, the first step of analyzing a plurality of LWD image logs acquired using a LWD (Logging While Drilling) logging tool can be performed by one or more specialists. At this step, preferably, at least 5 thousand meters of LWD image log are used, adding data from all existing wells in the data set.

Specifically, the first step of analyzing a plurality of image logs comprises classifying a plurality of sections from the LWD image logs into one of three quality categories, namely:
good—section where it is possible to identify boundaries between rock layers, as well as textural elements internal to the layers;
medium—section where it is possible to identify boundaries between layers of rocks, but it is not possible to identify elements internal to them; and
poor—missing section of boundaries between layers or their internal characteristics.

In this sense, there are no requirements regarding the length of the classified sections, that is, in a single log, there can be short sections falling into the good category and longer sections falling into the medium category, for example.

In this way, the result of the first step described above is the classified LWD image logs.

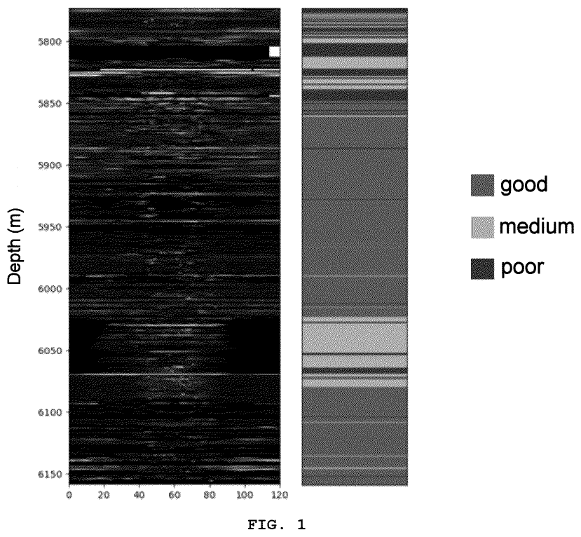

As an illustration and example, FIG. 1 shows a visualization of the result of the first step of analyzing a plurality of LWD image logs, where each quality category was associated with a color.

The image logs provide 360° coverage of the well wall with a vertical resolution of 0.5 cm. The LWD tool operates by emitting acoustic energy and then measuring the amplitude and transit time of the reflected signal. To achieve this, there are numerous sensors around the LWD tool (around 100 to 120 channels) to read the well wall.

The data resulting from acquisition by the LWD tool is a distribution matrix with a number of columns equivalent to the number of channels existing in the LWD tool and the number of rows equal to the logged extension divided by the vertical resolution of the tool.

The second step comprises processing a plurality of LWD image logs, as well as the plurality of LWD image logs classified in the first step, which include a plurality of sections classified into three quality categories: good, medium or poor.

More specifically, the second step of processing a plurality of LWD image logs comprises removing spurious points from the LWD image logs and/or from the LWD image logs classified into the three quality categories.

Due to the fact that reservoirs have different thicknesses, the data acquisition rate in different logging operations may vary and if it may be desired to log only specific sections of a given reservoir, each image log may have a different extension. In other words, although the number of data columns remains constant, the number of rows will depend on the conditions of each acquisition. On the other hand, the dimensions for inputting data into a neural network are of a fixed size. In addition, the number of rows in an image log can reach hundreds of thousands, which means an order of magnitude greater than the conventional size of neural networks, and larger sizes imply greater computational effort for training and using the neural networks.

Therefore, the step of processing a plurality of LWD image logs additionally comprises defining a single classification window of 120 rows and 120 columns. In this way, it comprises subdividing the LWD image logs and/or the classified LWD image logs into smaller pseudo-images of the same size.

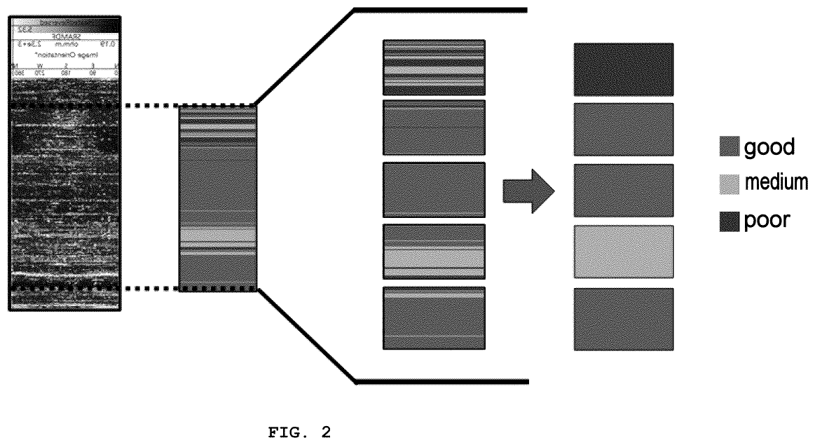

Next, the second step further comprises defining a single quality classification, which is mostly found in that section, for the pseudo-images of the classified LWD image logs. Attention must be paid to the total balance of the data in the database, that is, the number of sections with good, medium and poor classification must be similar, as illustrated in FIG. 2.

The third step of performing the normalization of each pseudo-image of the LWD image logs and/or the classified LWD image logs, according to the distribution of values found in its own value matrix, results in the absence of disparities in the distribution range in the images used in the fourth step, namely training the LWD image log quality assessment model.

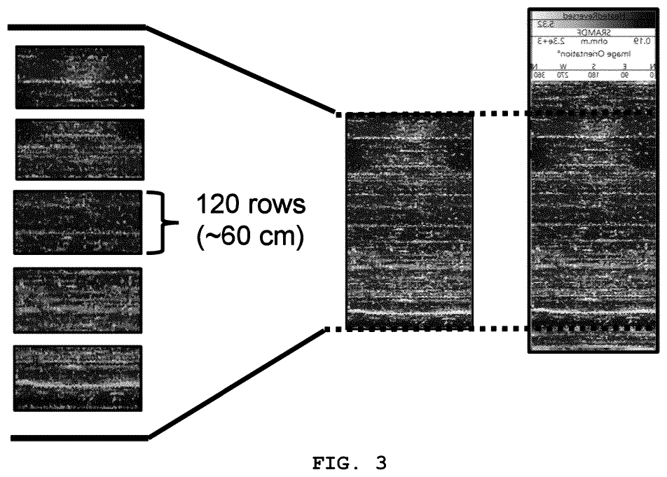

Furthermore, the third step of performing the normalization of each pseudo-image of the LWD image logs and/or classified LWD image logs comprises performing data augmentation with the objective of increasing the amount of data for training, from the data that already exists in the database. In particular, the data augmentation procedure of mirroring all images generated so far is used, that is, the LWD image logs and/or the classified LWD image logs, as illustrated in FIG. 3.

The fourth step comprises training a neural network model to assess the quality of the LWD image log.

In this sense, for a neural network to be able to correctly interpret the content of the LWD image logs to be classified, it first needs to be trained for this objective. In the context of neural networks, this consists of providing a series of images at the input of the network and comparing the classification returned by the same with the real classifications already known of these same images. Based on errors made by the neural network, its internal parameters (weights associated with neurons) are adjusted by means of an optimization algorithm, which seeks to minimize these errors in order to improve responses until a level of accuracy considered satisfactory is reached.

Specifically, the fourth step of training the LWD image log quality assessment model comprises training the neural network model for LWD image log quality assessment from inputs including the LWD image logs and the classified LWD image logs, which have gone through the second step of processing a plurality of LWD image logs and the third step of performing normalization of each pseudo-image of the LWD image logs and/or the classified LWD image logs.

Furthermore, the neural network model for assessing the quality of the LWD image log comprises a convolutional neural network architecture, specifically, a VGG16 network at its beginning, and, next, the output of this network feeds a direct network (FCN, Fully Convolutional Network), wherein the output of this last network is compared with the corresponding classification.

As to the VGG16 convolutional neural network, the first two layers have 64 channels of filter size 3*3 and same padding. Next, after a maximum pass pooling layer (2, 2), two layers that have convolution layers of filter size 256 and filter size (3, 3); followed by a maximum pass accumulation layer (2, 2), which is the same as the previous layer. This way, it comprises 2 convolution layers of filter size (3, 3) and filter size 256. After that, there are 2 sets of 3 convolution layers and a maximum pool layer. Each has 512 filters of size (3, 3) with the same padding. This image is then passed to the stack of two convolution layers.

Regarding the direct network, this includes two layers, wherein the first layer contains 2048 nodes and the second layer contains 1024 nodes and wherein each node is followed by the Rectified Linear Units function for its activation.

After the fourth step of training a neural network model for assessing the quality of the LWD image log, the neural network model trained for assessing the quality of the LWD image log is capable of performing the classification of a LWD image log according to its quality, specifically in the three quality categories, good, medium or poor.

The fifth step of classifying the LWD image log according to its quality comprises using the trained neural network model to assess the quality of the LWD image log, which is the result of the fourth step. Specifically, the step of classifying the LWD image log according to its quality comprises classifying a plurality of sections of the LWD image log into three quality categories, including: good, medium or poor.

Specifically, the three quality categories are:
good—section where it is possible to identify boundaries between rock layers, as well as textural elements internal to the layers;
medium—section where it is possible to identify boundaries between layers of rocks, but it is not possible to identify elements internal to them; and
poor—missing section of boundaries between layers or their internal characteristics.

In particular, the fifth step of classifying the LWD image log according to its quality occurs after the second step of processing a plurality of LWD image logs and the third step of performing normalization of each pseudo-image LWD image logs and/or classified LWD image logs.

Specifically, the fifth step of classifying the LWD image log according to its quality includes using a trained neural network model to assess the quality of the LWD image log.

In particular, the method for assessing the quality of LWD image logs can be used directly at the drilling location in order to immediately obtain automated classification of the LWD image log being acquired and thus assist in decision making. In an illustrative and exemplary way, immediately after the LWD logging operation, still during the drilling of the well, the collected data is received on the surface on the rig and transmitted to professionals in the onshore office, to carry out its quality classification. To do so, the data can be loaded into a commercial software, such as petrophysics software, where then there is run the code or set of instructions comprising the trained neural network model that perform the method for assessing the quality of LWD image logs of the present invention, which quickly and directly generates a quality log of that uploaded image. Based on this quality log and the intended objectives for the well, the petrophysicists responsible for monitoring the acquisition can decide on the best operational sequence to be adopted—perform a new LWD image log, perform a wireline image log or not acquire data additional image.

As a consequence of the ability to assess the quality of the LWD image log in real time, automatically, unnecessary expenditure of financial resources on redundant acquisitions is avoided, as well as the unnecessary availability of the wireline imaging tool, which could prove to be a critical resource. Additionally, it also prevents the well data acquisition step from being completed without an image of satisfactory quality having been acquired, necessary for the adequate development of the production design and for an optimized well completion.

In an example of an embodiment of the method according to the present invention, starting from the second step of processing the data generated by the experts, the image logs of 11 different wells were subdivided into 6868 pseudo-images to carry out the fourth step of training the LWD image log quality assessment model, generating inputs of fixed dimensions for the neural network and a significant number of individual images for training (an important factor for the network performance), as well as maintaining a reasonable amount of information in each image so that the network has the ability to make distinctions between the same.

Complementarily, by way of example, according to a preferred embodiment of the present invention, variations of neural networks and parameters were tested, presented in table 1 below.

TABLE 1
Example of parameters and neural network structures
tested in different combinations

| CNN | FCN | Activation | LR | Optimizer |
|---|---|---|---|---|
| ResNet 50 | 1024 | Sigmoid | 2.00E−2 | Adam |
| VGG16 | 2048-1024 | Sigmoid- | 2.00E−3 | SGD |
| | | Sigmoid | | |
| Inception | 1024-512 | ReLu-ReLu | 2.00E−4 | |
| Xception | | | 2.00E−5 | |

In table 1, the CNN column represents the type of used convolutional network, the FCN column represents the number and size of the layers of the direct neural network coupled to the convolutional network, the activation column represents the activation functions used in each layer of the direct network, the LR column represents the learning rate used during the training and the optimizer column represents the search method used in the training process.

Regarding performance, as an example, to speed up the training process, a set of pre-defined weights, available in the tensorflow library, was used to initialize the convolutional network, where the weights are obtained from training carried out using the free ImageNet repository as a database. Additionally, a separate pre-training of the direct neural network (FCN) was carried out, with the aim of accelerating the subsequent global training of the LWD image log quality assessment model. As a result, according to an example, an average of 16 epochs were required for the global training, considering all tested configurations. Furthermore, in order to avoid problems of overfitting the available data, the model selected for each configuration was the one corresponding to the smallest error calculated based on the validation data.

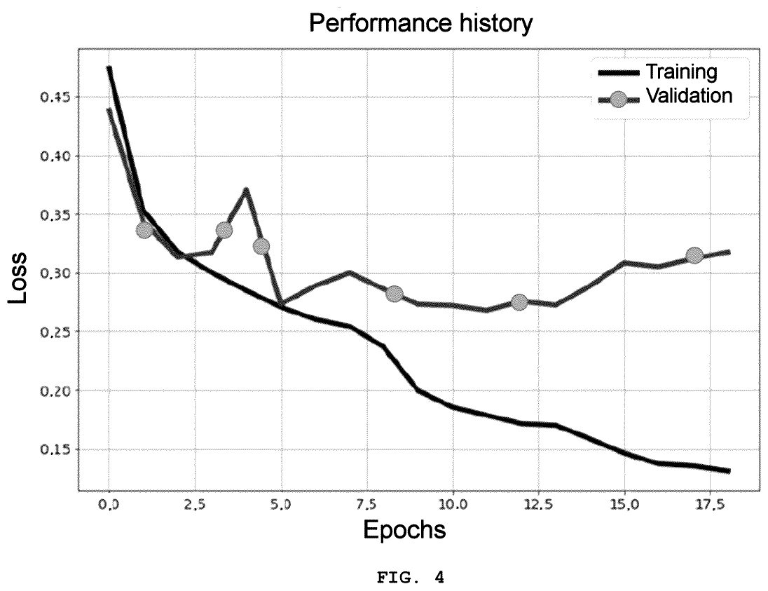

FIG. 4 presents a training graph of the neural network model to perform the method for assessing the quality of LWD image logs, specifically the configuration of the neural network model that presented the best performance among all the combinations tested. As can be noted in FIG. 4, the best performing configuration that stood out was a VGG16 convolutional neural network connected to a 2-layer direct network with sizes 2048 and 1024 and ReLu activation functions, using a learning rate of 2E-5 and the Adam optimizer.

Other mechanisms, subdividing the data set into batches and varying the learning rate during training itself, can also be used to optimize the process (i.e., speed up training and obtain better results, in terms of error reduction).

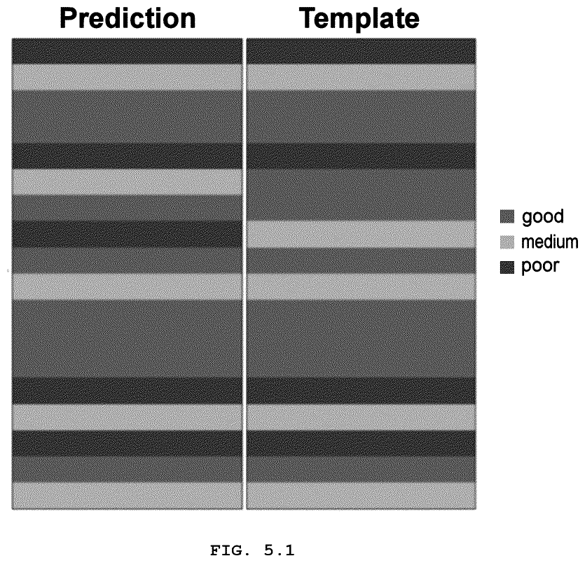

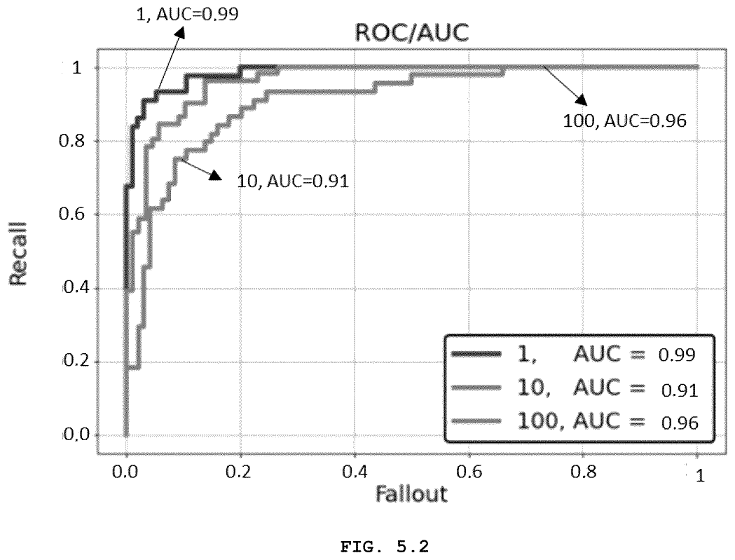

To demonstrate, as an example, the accuracy and robustness of the trained model to perform the method for assessing the quality of LWD image logs, a visualization of the blind test is presented in FIG. 5.1, comparing the response of said model with the responses about the classifications given by expert petrophysicists, which were used to train the said model. In addition, in FIG. 5.2 and table 2, a summary of the main metrics for assessing machine learning models is presented: precision, recall, accuracy, ROC and AUC, which were used to assess the model trained to perform the method of present invention.

TABLE 2
Result of the blind test carried out to assess the model training

| Class | Precision | Recall | Accuracy | Samples |
|---|---|---|---|---|
| 1 | 92.7% | 88.4% | 90.5% | 43 |
| 10 | 75.6% | 77.3% | 76.4% | 44 |
| 100 | 84.6% | 86.3% | 85.4% | 51 |
| Macro Average | 84.2% | 84.0% | 84.1% | 138 |
| Weighted Average | 84.2% | 84.1% | 84.1% | 138 |

Those skilled in the art in the technical field of mechanical engineering will value the knowledge presented herein and will be able to reproduce the invention in the presented embodiments and in other variants, encompassed by the scope of the attached claims.

1. A method for assessing the quality of LWD (Logging While Drilling) image logs, characterized in that it comprises:
performing the processing of a plurality of LWD image logs;
subdividing the LWD image logs into smaller pseudo-images of the same size;
performing the normalization of each pseudo-image of the LWD image logs; and
classifying the LWD image log according to its quality, which comprises classifying a plurality of sections of the LWD image log into three quality categories, including: good, medium or poor, using a trained neural network model for quality assessment of the LWD image log.

2. The method according to claim 1, characterized in that the step of performing the processing a plurality of LWD image logs comprises removing spurious points from the LWD image logs.

3. The method according to claim 1, characterized in that the step of performing the processing a plurality of LWD image logs additionally comprises defining a single classification window of 120 rows and 120 columns.

4. The method according to claim 1, characterized in that it additionally comprises performing data augmentation.

5. The method according to claim 1, characterized in that the good quality category comprises a section where it is possible to identify boundaries between rock layers, as well as textural elements internal to the layers; the medium quality category comprises a section where it is possible to identify boundaries between layers of rocks, but it is not possible to identify elements internal to them; and the poor quality category comprises a missing section of boundaries between layers or their internal characteristics.

6. The method according to claim 1, characterized in that the neural network model for assessing the quality of the LWD image log comprises a convolutional neural network architecture followed by a direct network.

7. The method according to claim 6, characterized in that the convolutional neural network is a VGG16 network.
